(19) United States
(12) Patent Application Publication
(10) Pub. No.: US 2026/0199776 A1
(43) Pub. Date: Jul. 16, 2026

(54) MODULAR VIDEO GAME CONTROLLER

(71) Applicant: Sony Interactive Entertainment Inc., Tokyo (JP)

(72) Inventor: Daniel Morales, Discovery Bay, CA (US)

(73) Assignee: Sony Interactive Entertainment Inc., Tokyo (JP)

(21) Appl. No.: 19/025,248

(22) Filed: Jan. 16, 2025

(51) Int. Cl. A63F 13/24

(52) U.S. Cl. CPC A63F 13/24

(57) ABSTRACT

A video game system includes a controller for a video game system that includes a controller body, a processor included in the controller body, and a user input device communicatively coupled with the processor and attached to one or more locations on the controller body. The user input device includes a graphical user interface configured to present selectable icons to control or navigate features of the video game system and a rotating member that rotates relative to an axis that intersects the controller body such that at least one or more of the selectable icons is selected or one or more of the features is controlled or navigated.

### BACKGROUND OF THE INVENTION

Game controllers have been used to control a variety of computing devices from computers to game consoles. Portable computing devices typically have had limited options for joystick type game controller inputs. Joysticks generally include a stick that pivots on a base. A mechanism in the base reports an angle or direction to the device it is controlling. In some implementations, the mechanism also reports a magnitude. Thumbsticks represent another option for controller input. Similar to joysticks, they pivot on a base and report an angle or direction (and sometimes a magnitude) to the device being controlled. Unlike a joystick, the thumbstick includes a small protrusion that the user moves with their thumb instead of a stick that the user grasps. Various set of buttons and triggers are commonly implemented in video game controllers for additional navigation and interaction with gaming application. Users may have varying preferences for what type of components they would like to use and where they would like the components situated on their video game controller.

### BRIEF SUMMARY OF THE INVENTION

According to one embodiment, a controller for a video game system includes a controller body, a processor included in the controller body, and a user input device communicatively coupled with the processor and attached to one or more locations on the controller body. The user input device includes a graphical user interface configured to present selectable icons to control or navigate features of the video game system and a rotating member that rotates relative to an axis that intersects the controller body such that at least one or more of the selectable icons is selected or one or more of the features is controlled or navigated.

The controller may include various optional embodiments. The controller may further include at least two thumbsticks, the user input device being couplable between the at least two thumbsticks. The user input device may be removably attached to the one or more locations on the controller body. The controller may further include a magnetic grid interface at least partially disposed between the at least two thumbsticks, the magnetic grid interface including a plurality of reference locations. The user input device may magnetically attach to the controller body at one or more of the reference locations. The controller may further include a plurality of user controls, where at least one of the user controls is magnetically attached to the controller body at one or more corresponding reference locations of the magnetic grid interface. The controller body may further include a front surface and a back surface. The graphical user interface may be disposed on the front surface and the rotating member is attached to the back surface of the controller body. The user input device may be attached to a top surface of the controller body. At least a portion of the user input device may be inwardly clickable for selecting one or more icons displayed on the graphical user interface. The graphical user interface may be a touchscreen for receiving touch input from a user for selecting one or more icons displayed on the graphical user interface. The user input device may further present, via the graphical user interface, a non-video game feature and to cause the processor to instruct the video game system about pausing a video game execution upon a selection of the non-video game feature via the graphical user interface or the rotating member. The controller may further include a wireless network interface housed in the controller body and coupled with the processor, where the processor is configured to receive notification information of the video game system via the wireless network interface, and, where the user input device is configured to receive, from the processor, the notification information and to present corresponding one or more notifications at the graphical user interface. The one or more notifications may include an incoming call alert or text message that is reviewable via the user input device. The processor may receive user input via the user input device in response to the one or more notifications causing a gaming application in progress to be paused.

According to another embodiment, a system includes a video game console and a controller communicatively couplable with the video game console. The controller includes a controller body, a processor included in the controller body, and a user input device communicatively coupled with the processor and attached to one or more locations on the controller body. The user input device includes a graphical user interface to present selectable icons to control or navigate features of the video game system and a rotating member that rotates relative to an axis that intersects the controller body such that at least one or more of the selectable icons is selected or one or more of the features is controlled or navigated.

The system may include various optional embodiments. The system may further include a wireless network interface housed in the controller body and coupled with the processor, where the processor is configured to receive notification information of the video game system via the wireless network interface, and, where the user input device is configured to receive, from the processor, the notification information and to present corresponding one or more notifications at the graphical user interface. The one or more notifications may include an incoming call alert or text message that is reviewable via the user input device. The processor may receive user input via the user input device in response to the notification information causing a gaming application in progress to be paused.

According to yet another embodiment, a method includes receiving user input via a graphical user interface or a rotating portion of a user input device, the user input device attached to a controller body of a controller, the controller communicatively coupled with a video game system, where the graphical user interface presents selectable icons to control or navigate features of the video game system and the rotating portion rotates relative to an axis that intersects the controller body such that at least one or more of the selectable icons is selected or one or more of the features is controlled or navigated. The method further includes sending a signal corresponding to the user input to the video game system, the signal causing a feature of the video game system to be controlled or navigated.

The method may include various optional embodiments. The method may further include receiving notification information, presenting corresponding one or more notifications at the graphical user interface, pausing causing a gaming application in progress, and receiving user input via a graphical user interface or a rotating portion of a user input device in response to the one or more notifications.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system that presents a dashboard, according to embodiments of the present disclosure.

FIG. 2 illustrates an example of a video game controller, according to some embodiments of the present disclosure.

FIG. 3 illustrates another example of a video game controller, according to some embodiments of the present disclosure.

FIG. 4A illustrates an exemplary user input device and video game controller, according to some embodiments of the present disclosure.

FIG. 4B illustrates an exemplary user input device and video game controller, according to some embodiments of the present disclosure.

FIG. 4C illustrates an exemplary user input device and video game controller, according to some embodiments of the present disclosure.

FIG. 4D illustrates an exemplary user input device and video game controller, according to some embodiments of the present disclosure.

FIG. 4E illustrates an exemplary user input device and video game controller, according to some embodiments of the present disclosure.

FIG. 4F illustrates an exemplary user input device and video game controller, according to some embodiments of the present disclosure.

FIG. 5A illustrates an example of a video game controller, according to some embodiments of the present disclosure.

FIG. 5B illustrates an example of a video game controller, according to some embodiments of the present disclosure.

FIG. 5C illustrates an example of a video game controller, according to some embodiments of the present disclosure.

FIG. 6 illustrates a method for using a video game controller to receive and transmit input, according to some embodiments of the present disclosure.

FIG. 7 depicts a system having a controller, according to embodiments of the present disclosure.

FIG. 8 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Video game controllers and other controllers on the market are designed to meet the needs and specifications of the majority of users. For example, conventional controllers are usually not modular, and thus their capabilities cannot be extended or customized. Users often have to purchase or otherwise access a variety of video game controllers to determine what set arrangement of buttons and controls best suits their needs. This can be an expensive task, and the user is not guaranteed satisfaction with any particular design. Accordingly, there is a need in the art for a modular video game controller that provides a user the ability to tune the arrangement of components based on their specific needs (e.g., ergonomic, types of gaming, motor skill issues, or the like). Embodiments of the present disclosure provide a modular video game controller that enables a user to customize components of the video game controller to their preferences. Further, in contrast to conventional controller implementations, embodiments described herein enable the extendibility and customization via a modular controller that includes an input device that can be mounted at possibly different locations of the controller and that can be further customized to user preferences, at least via software, as needed.

In the interest of clarity of explanation, the embodiments may be described in connection with a video game system including a video game console. However, the embodiments are not limited as such and similarly apply to any other type of a computer system. Generally, a computer system presents a dashboard in a GUI on a display. The dashboard presents UI elements, each corresponding to an application, service, or collection of information.

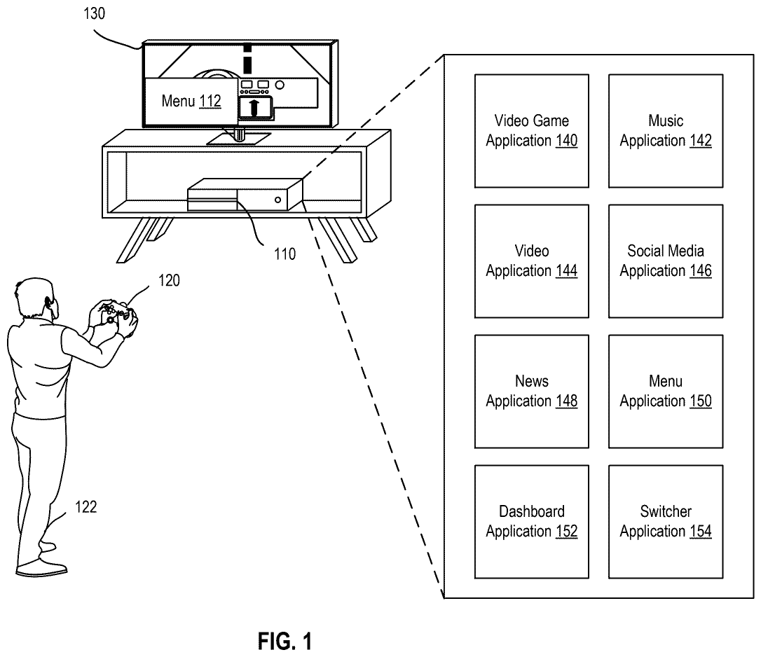

FIG. 1 illustrates a computer system that presents a dashboard, according to an embodiment of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 200 (e.g., over a wireless network) and with the display 130 (e.g., over a communications bus). A user 122 operates the video game controller 200 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login). In addition, the video game console 110 includes a menu application 150, a dashboard application 152, and a switcher application 154. The menu application 150 can present a home user interface (UI) in a GUI of the display 130. The dashboard application 152 can present an arrangement of interactive UI widgets in a dashboard page on the GUI. And the switcher application 154 can present a ribbon of UI elements in a ribbon menu on the GUI to allow scrolling between different UI elements and switching between corresponding applications.

The video game controller 200 is an example of an input device. The video game controller 200 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 200 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 200 requesting interactions with the menu 112, an underlying application (e.g., the menu application 150, the dashboard application 152, or the switcher application 154 as applicable) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the user 122, activating and/or powering-on the video game consol 110 etc.) and/or by navigating one or more menus and/or sub-menus of the video game console 110 (e.g., menu 112).

In general, the switcher application 154 may facilitate selection of a first subset of tiles to present in an immediate selection area of a library interface, as described in more detail below. The switcher application 154 may populate the first subset of tiles with tiles associated with system applications, video game applications, other forms of content, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

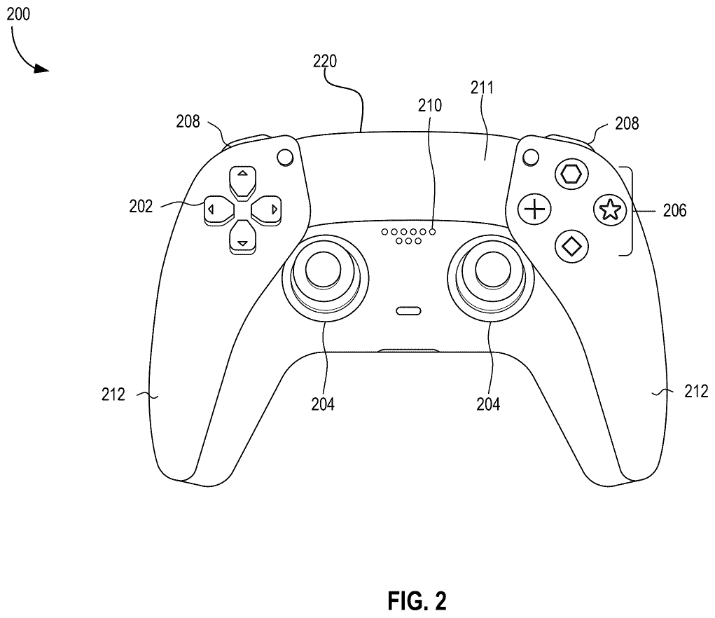

In FIG. 2, the DualSense® controller is illustrated as a non-limiting example of video game controller 200. Such a controller typically has two handles 212 and a central body 220. Various controls are distributed over the video game controller 200, typically in local groups. Examples include a left button group forming a directional pad 202, which may comprise directional controls and/or one or more shoulder buttons or system buttons 206, which comprise function controls and/or one or more shoulder buttons. The controller also includes left and/or right thumbsticks 204, which may optionally also be operable as buttons by pressing down on them.

As shown in FIG. 2, the video game controller 200 can include mechanisms for providing input to the video game console 110. For example, the video game controller 200 can include a directional pad 202, thumbsticks 204, buttons 206, and triggers 208. Any combination of the directional pad 202, one or both of the thumbsticks 204, one or more of the buttons 206, and one or both of the triggers 208 can be used by an end user (e.g., a video game player) to provide input to the video game console 110. The video game controller 200 can also include handles 212, which can be used to hold or grip the video game controller 200 while an end user operates the video game controller 200 to provide the input the video game console 110. The video game controller 200 can also include ports 210 that enable audio transducers included in the video game controller 200 to record sounds in an environment surrounding the video game controller 200 and emit audio to the environment surrounding the video game controller 200. Although not shown, the video game controller 200 can include other components such as one or more touch sensors for detecting physical touching of the video game controller 200 (e.g., by a human, another video game controller, an electronic device, and the like), display screens for displaying content (e.g., control and video game content) and receiving input to the video game controller 200 (e.g., touchscreen input), light sources (e.g., light emitting diodes) for emitting light and other signals to the environment surrounding the video game controller 200, and the like. The foregoing mechanisms of the video game controller 200 are not intended to be limiting and other mechanisms may be included in the video game controller 200.

The controller (typically in the central portion of the device) may also comprise one or more system buttons 206, which typically cause interaction with an operating system of the entertainment device rather than with a game or other application currently running on it; such buttons may summon a system menu or allow for recording or sharing of displayed content. Furthermore, the video game controller 200 may comprise one or more other elements such as a touchpad 211, a light for optical tracking (not shown), a screen (not shown), haptic feedback elements (not shown), triggers (not shown), and the like.

Similarly with conventional controllers, the thumbsticks 204 may move in a (due) north direction, which may be defined as the thumbstick direction that is normal to and oriented towards the side of the Dualsense® controller that houses the shoulder buttons thereof, such a (due) north direction being depicted in FIG. 2.

As will be appreciated by persons skilled in the art, in order to realize the aforementioned advantages of embodiments of the present description, one or both thumbsticks 204 may be replaced with a respective user input device 400, to be described in further detail below. Alternatively, one or more of the user input devices 400 may be detachably connectable to video game controller 200. For example, the DualSense® Edge controller comprises removable thumbstick modules so that users may replace damaged/worn thumbstick modules. Thus, a user input knob device 300 may take the form of such a removable/replaceable thumbstick module, and users may connect one or more user input devices with their DualSense® Edge controller (or other handheld controller comprising detachable/removable/replaceable thumbstick modules).

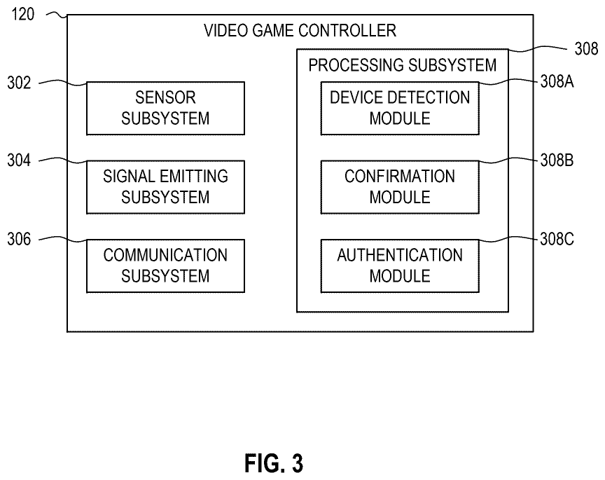

FIG. 3 illustrates another example of a video game controller. As shown in FIG. 3, the video game controller 200 can include a sensor subsystem 302, a signal emitting subsystem 304, and a communication subsystem 306, and a processing subsystem 308.

The sensor subsystem 302 can include sensors for sensing an operation of the video game controller 120, an external environment of the video game controller 200 (e.g., an environment surrounding the video game controller 120), an internal environment of the video game controller 200 (e.g., an environment within the video game controller 120), and the like. Examples of the sensors included in the sensor subsystem 302 can include, but are not limited to, image sensors, infrared sensors, depth cameras, event detection sensors, light sensors, microphones, sound sensors, audio transducers, position determining sensors, ultrawide band sensors, magnetic sensors, orientation sensors, proximity sensors, accelerometers, gyroscopes, inertial measurement units (IMUs), and the like.

The signal emitting subsystem 304 can include devices for emitting signals. A signal emitted by a device or devices of the signal emitting subsystem 304 can include a light component (e.g., visible, and/or infrared light), an audible component (e.g., a sound), and/or a haptic feedback component (e.g., a vibration). Examples of light that can be included as a component of a signal emitted by a device or devices of the signal emitting subsystem 304 include visible light, infrared light, laser light, steady light, strobe light, flashing light, colored light, light patterns, light beams, modulated light, and the like. Examples of audio that can be included as a component of a signal emitted by a device or devices of the signal emitting subsystem 304 include sounds, noises, music, tones, chimes, songs, ringtones, variable volume audio, and the like. Examples of haptic feedback that can be included as a component of a signal emitted by a device or devices of the signal emitting subsystem 304 include vibrations, surface frictions, thermal feedback, electromagnetic feedback, ultrasonic feedback, and the like. Examples of devices included in the signal emitting subsystem 304 can include, but are not limited to, audio transducers such as speakers, light sources such as LEDs, haptic feedback devices such as a vibrator, and others.

The communication subsystem 306 can include various hardware such as circuitry, radios, modules, transceivers, and software for enabling the video game controller 200 to communicate using wireless and/or wired communication. For example, the various hardware and software can enable the video game controller 200 to communicate with a network, a cloud-based storage system, another device such as another video game controller, electronic device, mobile phone, input device, video game console, and the like. The various hardware and software can also enable the video game controller 200 to communication using any wired and/or wireless communication technology, standard, protocol, and the like, and using any kind of network, public or private, wired, or wireless, and the like. Examples of such technologies, standards, and protocols include NFC, Bluetooth, IrDA; RFID; Matter; ZigBee; 3G; 4G; 5G; 6G; WLAN; Z-wave; Wi-Fi and Wi-Fi Direct; UWB; USB; ANT and ANT+; UHF; VHF; SCPS; and the like.

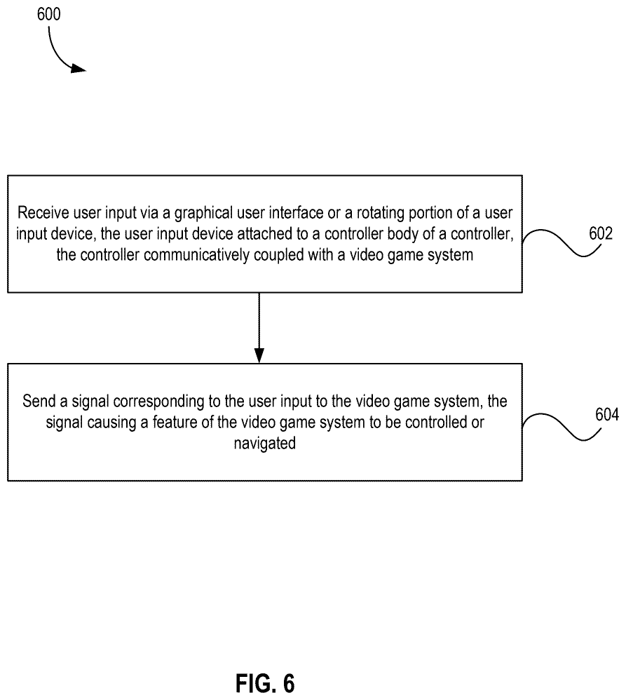

The processing subsystem 308 can include one or more processors (not shown) and one or more memories (not shown). The one or more processors can read one or more programs from the one or more memories and execute them. Each processor of the one or more processors can be of any type of processor. Examples of processors include, but are not limited to, microprocessors, microcontrollers, graphical processing units, digital signal processors, application-specific integrated circuits, field programmable gate arrays, or any combination thereof. Additionally, each processor of the one or more processors can include multiple cores, arrays, coprocessors, local cache memory layers, and the like. Each memory of the one or more memories can be non-volatile and can include any type of memory or memory device that retains stored information when powered off. At least one memory of the one or more memories can include a non-transitory computer-readable storage medium from which the one or more processors can read instructions. Examples of memories, memory devices, computer-readable storage media include, but are not limited to, include electrically erasable and programmable read-only memory, flash memory, magnetic disks, memory chips, read-only memory, RAM, an ASIC, a configured processor, optical storage, and the like. The one or more processors, either individually or collectively, can execute programs stored in the one or more memories to perform the operations and/or methods, including parts thereof, described throughout. For example, the one or more processors can execute programs stored in the one or more memories to perform the process 600 for operating a video game controller to perform controller-driven video game console login as shown in FIG. 6 below and to be described later.

In some implementations, the processing subsystem 308 can include, but is not limited to, a device detection module 308A, a confirmation module 308B, and an authentication module 308C. Each of the device detection module 308A, the confirmation module 308B, and the authentication module 308C can be implemented in hardware (e.g., a processor, computer circuitry, and the like), software, or a combination thereof.

The device detection module 308A can be configured to detect whether an electronic device is within a predetermined distance from the video game controller 120. Examples of electronic devices include, but not are not limited to, video game controllers, mobile phones, computing devices such as tablet computers, laptop computers, and the like, video game consoles, wearable devices, and the like. In some implementations, the predetermined distance can be 0, 1, 2, 3, 4, 5, 6, 7, 8, 9, 10, 11, or 12 inches or any distance therebetween. The device detection module 308A can detect that the electronic device is within the predetermined distance from the video game controller 200 by detecting a signal that is emitted from the electronic device. In some implementations, the device detection module 308A can detect that an electronic device is within a predetermined distance from the video game controller 200 in response to and/or after the video game controller 200 receives a notification. In some implementations, the signal can be an audio signal, a light signal, or a combination thereof.

In some implementations, in the case the electronic device emits an audio signal, the device detection module 308A can detect the emitted audio signal (e.g., using one or more audio transducers included in the sensor subsystem 302). In some implementations, to determine whether the electronic device is within the predetermined distance from the video game controller 120, the device detection module 308A can determine whether the audio signal emitted by the electronic device has a particular frequency and/or a particular amplitude. In the event that the audio signal emitted by the electronic device has the particular frequency and/or the particular amplitude, the device detection module 308A can determine that the electronic device is within the predetermined distance from the video game controller 120.

In some implementations, in the case the electronic device emits a light signal, the device detection module 308A can detect the emitted light signal (e.g., using one or more image sensors and/or light sensors of the sensor subsystem 302). In some implementations, to determine whether the electronic device is within the predetermined distance from the video game controller 120, the device detection module 308A can determine whether the light signal emitted by the electronic device has a particular frequency, a particular intensity (e.g., brightness), and/or a particular pattern. In the event that the light signal emitted by the electronic device has the particular frequency, the particular intensity, and/or the particular pattern, the device detection module 308A can determine that the electronic device is within the predetermined distance from the video game controller 120.

In some implementations, the device detection module 308A can detect that the electronic device is within the predetermined distance from the video game controller by detecting that the electronic device is communicating with the video game controller 200 using at least one of a Near Field Communication (NFC) protocol or a Bluetooth protocol. In some implementations, the video game controller can be wirelessly paired with and/or wirelessly coupled to the electronic device using the communication subsystem 306 and using a wireless pairing and/or coupling protocol such as the NFC protocol or Bluetooth protocol and the electronic device can be considered to be communicating with the video game controller 200 when the video game controller 200 is wirelessly paired with and/or wirelessly coupled to the electronic device. In some implementations, to determine whether the electronic device is within the predetermined distance from the video game controller 120, the device detection module 308A can determine whether the video game controller 200 is wirelessly paired with and/or wirelessly coupled to the electronic device using the NFC protocol and/or the Bluetooth protocol, and, in the event that the video game controller 200 detects that the video game controller 200 is wirelessly paired with and/or wirelessly coupled to the electronic device using the NFC protocol and/or the Bluetooth protocol, the device detection module 308A can determine that the electronic device is within the predetermined distance from the video game controller 120.

The device detection module 308A can also detect that the electronic device is within the predetermined distance from the video game controller 200 by detecting that the electronic device is in physical contact with the video game controller 200 and/or has physically contacted the video game controller 120. In some implementations, the electronic device can be brought into physical contact with the video game controller 200 and the device detection module 308A can detect the electronic device is in physical contact with and/or has physically contacted the video game controller 120. The device detection module 308A can detect whether the electronic device is in physical contact with and/or has physically contacted the video game controller 200 using one or more sensors of the sensor subsystem 302 (e.g., proximity sensors, IMUs) and/or a wireless communication transceiver (e.g., a Bluetooth-enabled radio, an NFC-enabled radio) of the communication subsystem 306. In some implementations, to determine whether the electronic device is in physical contact with and/or has physically contacted the video game controller 120, the device detection module 308A can obtain a signal from the wireless communication transceiver and use the signal obtained from the wireless communication transceiver to determine that an electronic device is within a close distance to the video game controller 200 (e.g., 0, 1, 3, 4 inches or anything distance therebetween). In the event the device detection module 308A determines that the electronic device is within a close distance to the video game controller 120, the device detection module 308A can obtain one or more signals from the one or more sensors and use the one or more signals obtained from the one or more sensors to determine that the electronic device is in physical contact with and/or has physically contacted the video game controller 120. For example, the device detection module 308A can obtain a signal from the wireless communication transceiver of the communication subsystem 306, use that signal to determine that the electronic device is within a close distance to the video game controller 120, obtain a signal from a proximity sensor of the sensor subsystem 302, and use that signal to determine that the electronic device is in physical contact with (e.g., touching) the video game controller 120. In another example, the device detection module 308A can obtain a signal from the wireless communication transceiver of the communication subsystem 306, use that signal to determine that the electronic device is within a close distance to the video game controller 120, obtain signals from an IMU of the communication subsystem 306, and use those signals to determine that the electronic device has physically contacted the video game controller 200 while the electronic device is or was within a close distance to the video game controller 120.

The confirmation module 308B can be configured to receive notifications. In some implementations, the notifications can be received from a video game console such as the video game console 110. In some implementations, the notifications received from the video game console can indicate that a login event has occurred at the video game console. In some implementations, the login event can correspond to a login inquiry generated by the video game console for logging into the video game console, logging into a video game executing on the video game console, and logging into other components. In some implementations, the notifications can be received from an electronic device such as the electronic device described above. In some implementations, the notifications received from the electronic device can indicate that a signal emitted by the video game controller 200 was received by the electronic device. In some implementations, the notification can also indicate that an application associated with a provider of the video game console is executing on the electronic device. In some implementations, the notification can be generated automatically by the electronic device in response to receiving the signal emitted by the video game controller 200 while an application associated with a provider of the video game console 110 is executing on the electronic device. In some implementations, the notification can be generated by the electronic device in response to an end user acknowledging the signal emitted by the video game controller 200 while using an application associated with a provider of the video game console that is executing on the electronic device and during a time in which the signal is emitted by the video game controller 120.

As described above the video game controller 200 can be configured to communicate using wireless communications and/or wired communications. In the case, the video game console is wirelessly coupled to the video game controller 200 or the electronic device, the confirmation module 308B can receive the notifications using a wireless transceiver of the communication subsystem 306. In the case the video game console is couple to the video game controller 200 or the electronic device using a wired connection, the confirmation module 308B can receive the notifications using a wired transceiver of the communication subsystem 306.

The confirmation module 308B can be configured to emit signals. In some implementations, the signal can be an audible signal (e.g., a sound output by an audio transducer of the signal emitting subsystem 304), a visual signal (e.g., a light emitted by a light source of the signal emitting subsystem 304), a vibration signal (e.g., a rumble emitted by a vibrator of the signal emitting subsystem 304), or a combination thereof. In some implementations, the signal can be emitted in response to the device detection module 308A detecting that an electronic device is within a predetermined distance from the video game controller 120.

The authentication module 308C can be configured to obtain a login credential for a video game player. In some implementations, the video game player can be an end user of the video game console, an end user of the electronic device, an end user of the video game controller 120, or a combination thereof. In some implementations, the video game player can be human video game player or computerized (e.g., artificially intelligent) video game player. In some implementations, the login credential for the video game player can be obtained from a server (e.g., a cloud-based storage server) storing login credentials for video game players, the electronic device, or a combination thereof. For example, the authentication module 308C can use a wireless or wired transceiver of the communication subsystem 306 to communicate with the server and/or the electronic device to obtain the login credential for the video game player from the server and/or the electronic device. In some implementations, the login credential can facilitate logging into the video game controller 120, the video game console, the electronic device, an application associated with a provider of the video game console that is installed on and/or executing on the electronic device, or a combination thereof. In some implementations, the authentication module 308C can obtain the login credential in response to and/or after a notification is received from the electronic device.

The authentication module 308C can also be configured to can transmit the login credential to the video game console. In some implementations, transmitting of the login credential serves as a response to the login event. The authentication module 308C can transmit the login credential to the video game console using a wireless communication transceiver of the communication subsystem 306. In some implementations, the login credential can be used by the video game console 110 to log into the video game console 110, log into a video game executing on the video game console 110, authenticate an end user or video game player, retrieve video game player settings, video game player preferences, video game statistics, and other data and information associated with video games, video game players, and/or video game consoles.

The foregoing subsystems of the video game controller 200 are not intended to be limiting and other subsystems may be included in the video game controller 120.

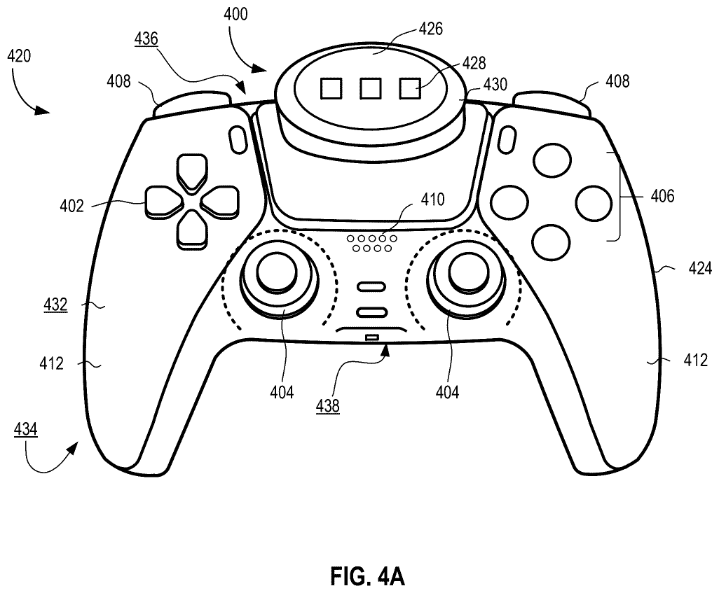

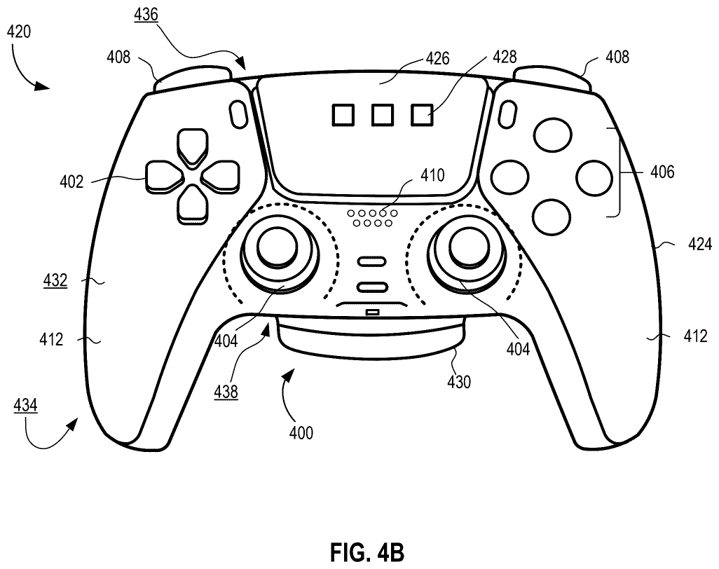

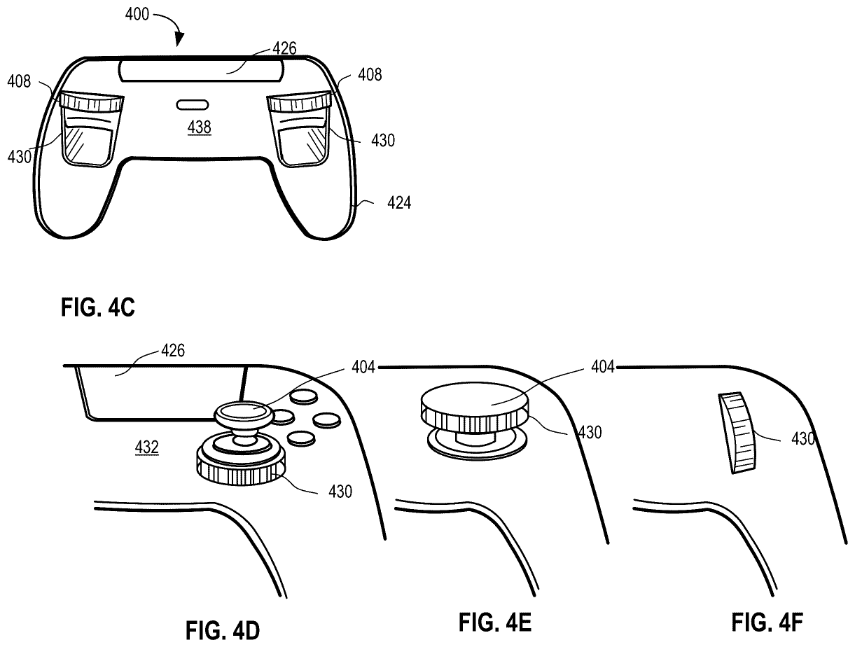

FIG. 4A illustrates a non-limiting example of a user input device 400 for use with video game controller 420. Video game controller 420 may include various embodiments as described with respect to other figures. Similar features may be similarly numbered may have similar form and function unless otherwise noted herein. For example, as shown in FIG. 4A, the video game controller 420 can include mechanisms for providing input to the video game console 110. For example, the video game controller 420 can include a directional pad 402, thumbsticks 404, buttons 406, and triggers 408. Any combination of the directional pad 402, one or both of the thumbsticks 404, one or more of the buttons 406, and one or both of the triggers 408 can be used by an end user (e.g., a video game player) to provide input to the video game console 110. The video game controller 420 can also include handles 412, which can be used to hold or grip the video game controller 420 while an end user operates the video game controller 420 to provide the input the video game console 110. The video game controller 420 can also include ports 410 that enable audio transducers included in the video game controller 420 to record sounds in an environment surrounding the video game controller 420 and emit audio to the environment surrounding the video game controller 420.

User input device 400 may be communicatively coupled with a processor of the video game controller 420. According to various embodiments and as shown in FIG. 4A, the user input device 400 may be attached to one or more locations on the controller body 424. In exemplary embodiments, the user input device 400 is removably attached to the video game controller 420. For example, the user input device 400 may include one or more coupling mechanisms (not shown) that removably attach to corresponding coupling mechanisms (not shown) on the video game controller 420.

The user input device 400 may include a graphical user interface 426 configured to present selectable icons 428 to control or navigate features of a video game system. In some embodiments, the graphical user interface 426 is a touchscreen for receiving touch input from a user for selecting one or more icons 428 displayed on the graphical user interface 426. For example, the graphical user interface 426 may function as a mini user interface on the controller body 424 that can be controlled via the rotating member 430. The graphical user interface 426 enables the user input device 400 to be used for navigation, for game functions (e.g., swipe the touchscreen for a weapon menu, and select via the dial a weapon), console functions (e.g., to view notifications), or other functions (e.g., to see/answer an incoming call).

In some embodiments, the user input device 400 is further configured to present, via the graphical user interface 426, a non-video game feature (e.g., notification information such as an incoming call, text, email, or application notification). The user input device 400 may cause a processor (such as a processor implemented in processing subsystem 308 as described with respect to FIG. 3) to instruct the video game system about pausing a video game execution upon a selection of the non-video game feature via the graphical user interface 426 or the rotating member 430.

According to various embodiments, the user input device 400 may further include a rotating member 430 that rotates relative to an axis that intersects the controller body 424 such that at least one or more of the selectable icons 428 is selected or one or more of the features of a gaming application displayed via the video game system is controlled or navigated. In various embodiments, at least a portion of the user input device 400 is inwardly clickable for selecting one or more icons 528 displayed on the graphical user interface 426.

The controller body 424 includes a front surface 432 and a back surface 434. The controller body 424 further includes a top surface 436 and a bottom surface 438. The user input device 400 may be removably attached to one or more of these surfaces (e.g., locations) on the controller body 424. As shown in FIG. 4A, the user input device 400 is attached to the front surface 432 and adjacent to the top surface 436. Further, the controller body 424 may include at least two thumbsticks 404 and the user input device 400 is couplable between the at least two thumbsticks 404.

FIG. 4B illustrates a non-limiting example of a user input device 400 for use with video game controller 420. Video game controller 420 may include various embodiments as described with respect to other figures. As shown in FIG. 4B, the user input device 400 may be coupled to the back surface 434 of the controller body 424. According to various embodiments, the user input device 400 may include a graphical user interface 426 that is separate from, but communicatively coupled to, the rotating member 430. In further embodiments, the rotating member 430 may include a secondary graphical user interface on the rotating member 430 as shown in FIG. 4A. For example, a user may prefer a larger graphical user interface 426 and/or the position of the rotating member 430 to be opposite the thumbsticks 404, directional pad 402, the system buttons 406, etc. Embodiments of the present disclosure advantageously provide a modular user input device 400 which is usable in several positions on the controller body 424 according to user preferences.

FIGS. 4C-4F illustrate various alternative embodiments of the rotating member 430 of the user input device 400 described above. The user input device 400 may include one or more rotating members 430. For example, as shown in FIG. 4C illustrates that a rotating member 430 is integrated with each corresponding trigger 408 on the back surface 434 of the controller body 424. The user input device 400 may only include one rotating member 430 integrated with one of the triggers 408 in other embodiments.

FIG. 4D illustrates a further alternative implementation of the rotating member 430 of the user input device 400. The user input device 400 may include one or more rotating members 430. As shown in FIG. 4D, a rotating member 430 may be integrated with a thumbstick 404 on the front surface 432 of the controller body 424. In some embodiments where the controller body 424 includes at least two thumbsticks 404, a rotating member 430 is integrated with one or both of the at least two thumbsticks 404. In further embodiments, the rotating member 430 may be the thumbstick 404 as shown in FIG. 4E.

Embodiments of the user input device 400 as described herein may have the rotating member 430 arranged in various locations as illustrated in FIGS. 4A-4E. The rotating member 430 may also be arranged in various orientations. For example, the rotating member 430 may be oriented horizontally and substantially parallel to the longest dimension of the controller body 424 as shown in FIGS. 4A-4E. In other embodiments and as shown in FIG. 4F, the rotating member 430 may be oriented vertically and substantially perpendicular to the longest dimension of the controller body 424.

Various features of the user input device 400 including the graphical user interface 426, the rotating member 430, etc., are communicatively coupled via a wireless network interface (not shown) housed in the controller body 424 and coupled with a processor (such as a processor implemented in the processing subsystem 308 described with respect to FIG. 3) and/or the network interface card via data lines. As such, data and controls can be exchanged between various features of the user input device 400 and the processors and/or the wireless network interface. Data lines may also communicatively couple various features of the user input device 400. In other embodiments, wireless communications can be used between features of the user input device 400 and the processor via wireless interfaces. Furthermore, various features of the user input device 400 including the graphical user interface 426, the rotating member 430, etc., receive power supplied via the same voltage rail or different voltage rails. For example, one or more voltage rail(s) are supplied power from a power source (e.g., a rechargeable battery or the like) of the video game controller 420.

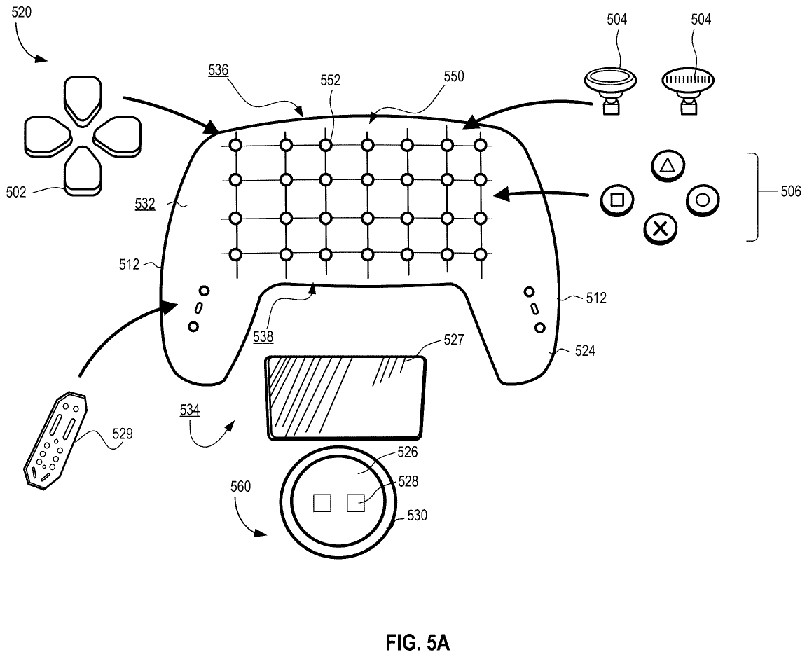

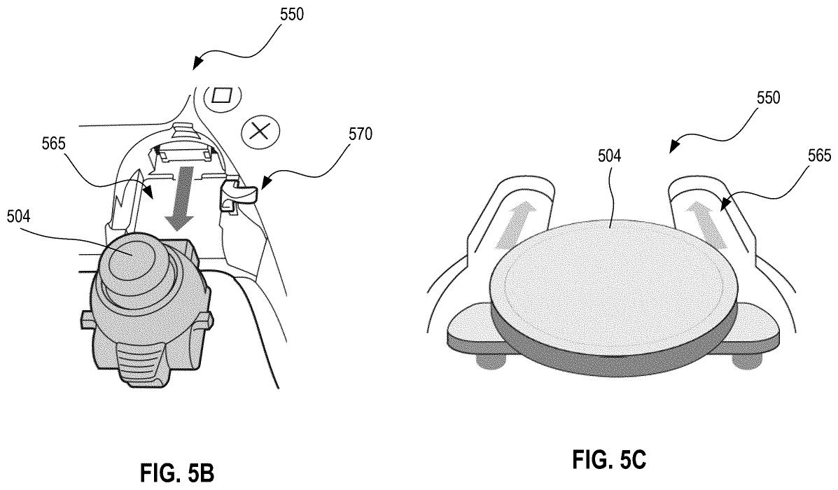

FIG. 5 illustrates a non-limiting example of a video game controller 520. Video game controller 520 may include various embodiments as described with respect to other figures. Similar features may be similarly numbered may have similar form and function unless otherwise noted herein. The controller body 524 includes a front surface 532 and a back surface 534. The controller body 524 further includes a top surface 536 and a bottom surface 538. According to various embodiments, a video game controller 520 includes a magnetic grid interface 550 disposed between two handles 512 on the top surface 536 of the controller body 524. The magnetic grid interface 550 may be configured to magnetically couple various components be used with the video game controller 520. The magnetic grid interface 550 may include a plurality of reference locations 552. In various embodiments, the magnetic grid interface 550 may further enable power and data coupling between user controls, in addition to the mechanical attachment, via the magnetic grid interface 550.

According to various embodiments, the magnetic grid interface 550 may include a user input device 560 magnetically attached to the controller body 524 at one or more of the reference locations 552. The user input device 560 may a graphical user interface 526 configured to present selectable icons 528 to control or navigate features of a video game system. The user input device 560 may further include a rotating member 530 that rotates relative to an axis that intersects the controller body 524 such that at least one or more of the selectable icons 528 is selected or one or more of the features of a gaming application displayed via the video game system is controlled or navigated.

In various embodiments, the magnetic grid interface 550 magnetically couples to a plurality of user controls. User controls may include a directional pad 502, one or more thumbsticks 504, buttons 506, etc. User controls may further include an additional graphical user interface 527, force sensors 529, additional rotating members (not shown), etc. Any combination of the directional pad 402, one or both of the thumbsticks 504, one or more of the buttons 406, and one or both of the triggers 408 can be used by an end user (e.g., a video game player) to provide input to the video game console. Each of the user control as described herein may include one or more corresponding magnets of opposite polarity to the magnetic grid interface 550 such that they are affixed thereto via magnetic force. The magnetic coupling between the user controls and the magnetic grid interface 550 provides mechanical attachment and may further provide electrical power and/or data exchange. For example, magnets within the magnetic grid interface 550 may include a pin structure that provides power and/or data and that couples with a mating connector on the user controls or vice versa. In other embodiments, user controls that do not require power or data (e.g., a navigational button that would have been otherwise mounted on a mechanical switch connected to a circuit, a thumbstick, etc.), may implement magnets that mount to corresponding mechanical switches.

Force sensors 529 may collect user data such as heart rate, pressure temperature, blood oxygen content, or the like, which may be output as part of a gaming application (e.g., as a reaction or feedback) as would be appreciated by one having ordinary skill in the art. In some embodiments, one or more of the user controls are permanently attached to the controller body 524 and other of the user controls are modular and magnetically coupled to the controller body 524. For example, at least two thumbsticks 504 may be magnetically attached to the controller body 524 and at least one of the user controls is removably, magnetically coupled to the controller body 524 at one or more corresponding reference locations 522 of the magnetic grid interface 550. In some embodiments, at least one of the user controls is removably, magnetically coupled to the controller body 524 at one or more corresponding reference locations 522 of the magnetic grid interface 550 between the at least two thumbsticks 504. Accordingly, in various embodiments, magnets of the magnetic grid interface 550 mechanically couple user controls such as the graphical user interface 526.

In some embodiments, the magnetic grid interface 550 is communicatively coupled with the processor that detects connections to the one or more reference locations 522. In response to detecting a new connection, the processor may output to the user (e.g., via the graphical user interface 526) a confirmation of what component and/or what reference location 522 was connected. User input may be received identifying the component and the connection point and the processor may store the information locally on the video game controller 520. In other embodiments, magnetically coupling components to the magnetic grid interface 550 is hardware-based and does not require any user input. For example, each component may have a processor that stores identifying information that is shared when the component is coupled to the magnetic grid interface 550 of the controller body 524 to initiate the processor of the video game controller 520. Accordingly, the identification information may be sent (e.g., wirelessly) to the processor of the video game controller 520.

In various embodiments, the user input device described herein (e.g., at least user input device 400 described in detail above with respect to other figures) may be magnetically coupled to the magnetic grid interface 550 at any desired reference location.

FIGS. 5B and 5C illustrate exemplary implementations of coupling the thumbsticks 504 (or any other user control described herein) to the magnetic grid interface 550 of the controller body 524. For example, as shown in FIG. 5B, the thumbstick 504 is slid into and out of a slot 565 and secured in position by a buckle or clip 570. In other embodiments, and as shown in FIG. 5C, the thumbstick 504 slides into and out of a slot 565 and the magnetic force of the magnetic grid interface 550 secures the thumbstick 504 in position.

FIG. 6 illustrates a method for using a video game controller to receive and transmit input. Various embodiments of process 600, including any blocks described herein, may be performed manually or under the control of the computer system described in FIG. 6, to be described in further detail below. Process 600 includes various operations for using a video game controller to receive and transmit input. Process 600 may include more or fewer operations than those described herein, and various operations may be performed in alternative configurations than those described herein. Process 600 may include block 602. At block 602, process 600 may include receiving user input via a graphical user interface or a rotating portion of a user input device where the user input device attached to a controller body of a controller, as described in detail above with respect to other figures. The rotating portion may rotate relative to an axis that intersects the controller body (e.g., an axis perpendicular to a top surface of the controller body) such that at least one or more of the selectable icons is selected or one or more of the features is controlled or navigated.

In at least some embodiments, the user input device is further configured cause the processor to instruct the video game system about pausing a video game execution upon a selection of the non-video game feature via the graphical user interface or the rotating member. The processor may be configured to receive user input via the user input device in response to the one or more notifications causing a gaming application in progress to be paused. For example, a gaming application may be paused in response to a user selecting (e.g., via the user input device) a notification associated with an incoming call to answer the call.

Process 600 may further include block 604. Block 604 may include sending a signal corresponding to the user input to the video game system, the signal causing a feature of the video game system to be controlled or navigated. In various embodiments, the controller is communicatively coupled with a video game system via mechanisms known in the art and the graphical user interface presents selectable icons to control or navigate features of the video game system. For example, the controller may be communicatively coupled with a video game system using a wireless network interface housed in the controller body and coupled with the processor. The processor may be configured to receive notification information of the video game system via the wireless network interface, and the user input device is configured to receive, from the processor, the notification information and to present corresponding one or more notifications at the graphical user interface. The one or more notifications may include an incoming call alert, text message, email, application notification, push alert, alarm, timer, or the like, which is reviewable via the user input device.

In one exemplary implementation, the user input device is communicatively coupled via Bluetooth to a user phone. In response to receiving an incoming call on the user phone, the user input device displaying a notification for the incoming call on the graphical user interface of the user input device. If user taps the screen of the graphical user interface, the call is taken, and the user input device sends a signal to the video game controller to pause a gaming application on the video game console. Similarly, for a text message received on a user phone, if the user taps the screen of the graphical user interface of the user input device, the game is paused, and the user may use the user input device to send a response message via the video game controller for display. Various notifications (e.g., a chat history or conversation thread) may be shown on a display of the video game system such as a television, computer screen, or the like.

Any of the methods described herein may be totally or partially performed with a computer system including one or more processors, which can be configured to perform the blocks. Any operations performed with a processor (e.g., aligning, determining, comparing, computing, calculating) may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the blocks of any of the methods described herein, potentially with different components performing a respective block or a respective group of blocks. Although presented as numbered blocks, blocks of methods herein can be performed at a same time or at different times or in a different order. Additionally, portions of these blocks may be used with portions of other blocks from other methods. Also, all or portions of a block may be optional. Additionally, any of the blocks of any of the methods can be performed with modules, units, circuits, or other means of a system for performing these blocks.

Some embodiments of the present disclosure include a system including one or more data processors and/or logic circuits. In some embodiments, the system includes a non-transitory computer readable storage medium containing instructions (e.g., executable instructions, one or more computer programs, or one or more applications) which, when executed on the one or more data processors, cause the one or more data processors to perform part or all of one or more methods and/or part or all of one or more processes and workflows disclosed herein. Some embodiments of the present disclosure include a computer-program product tangibly embodied in a non-transitory machine-readable storage medium, for example, in the form of a computer program including a plurality of instructions executable by one or more processors. The instructions can be configured to cause one or more data processors to perform part or all of one or more methods and/or part or all of one or more processes disclosed herein, including, for example, process 600 of FIG. 6.

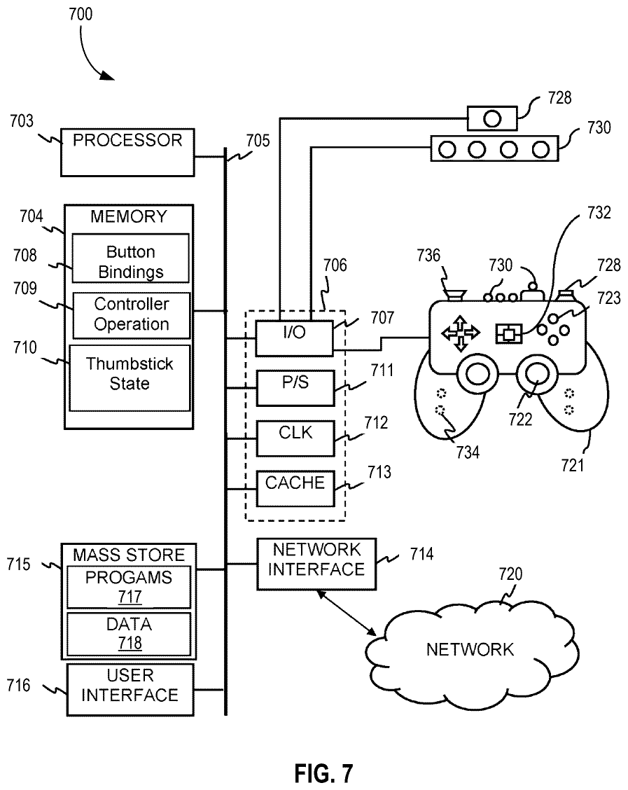

FIG. 7 depicts a system 700 having a controller according to embodiments of the present disclosure. The system 700 may include one or more processor units 703, which may be configured according to well-known architectures, such as, e.g., single-core, dual-core, quad-core, multi-core, processor-coprocessor, cell processor, and the like. The marketplace server may also include one or more memory units 704 (e.g., random access memory (RAM), dynamic random-access memory (DRAM), read-only memory (ROM), and the like).

The processor unit 703 may execute one or more programs 717, portions of which may be stored in the memory 704 and the processor 703 may be operatively coupled to the memory, e.g., by accessing the memory via a data bus 705. The controller operation 709 may also use button bindings 708 to interpret button presses from the controller 721 to determine inputs for the system. The controller operation, button bindings and thumbstick state 710 may also be stored as data 718 in the Mass Store 715.

The system 700 may also include well-known support circuits 706, such as input/output (I/O) 707, circuits, power supplies (P/S) 711, a clock (CLK) 712, and cache 713, which may communicate with other components of the system, e.g., via the bus 705. The computing device may include a network interface 714 to a network 720. The processor unit 703 and network interface 714 may be configured to implement a local area network (LAN) or personal area network (PAN), via a suitable network protocol, e.g., Bluetooth, for a PAN. The computing device may optionally include a mass storage device 715 such as a disk drive, CD-ROM drive, tape drive, flash memory, or the like, and the mass storage device may store programs and/or data. The system may also include a user interface 716 to facilitate interaction between the system and a user. The graphical user interface may include a display device such as monitor, Television screen, speakers, headphones, or other devices that communicate information to the user. The display device may include visual, audio, or haptic display or some combination thereof. A controller 721 such as a mouse, keyboard, game controller, joystick, etc. may communicate with an I/O interface and provide control of the system to a user. The controller has one or more thumbsticks 722 coupled to the controller.

The controller 721 may have conventional buttons 723 that provide control signals commonly used during playing of video games. Such video games may be implemented as processor readable data and/or instructions from the programs for controller operation 709, which may be stored in the memory 704, or other processor readable medium such as one associated with the mass storage device 715.

The thumbstick 722 may generally be configured so that moving the thumbstick left or right signals movement along the X axis and moving it forward (up) or back (down) signals movement along the Y axis. In thumbsticks that are configured for three-dimensional movement, twisting the stick left (counterclockwise) or right (clockwise) may signal movement along the Z axis. These three axes—X Y and Z—are often referred to as roll, pitch, and yaw, respectively, particularly in relation to an aircraft.

In addition to conventional features, a tracking device incorporated into the controller 721 may include one or more inertial sensors 732 having a single mass, which may provide position and/or orientation information to the processor 703 via inertial signals, e.g., displacement signal. Orientation information may include angular information such as a tilt, roll or yaw of the controller 721. By way of example, the inertial sensors may include any number and/or combination of accelerometers, gyroscopes, or tilt sensors. In a preferred embodiment, the inertial sensors include tilt sensors adapted to sense orientation of the joystick controller with respect to tilt and roll axes, a first accelerometer adapted to sense acceleration along a yaw axis and a second accelerometer adapted to sense angular acceleration with respect to the yaw axis. An accelerometer may be implemented, e.g., as a MEMS device including a mass mounted by one or more springs with sensors for sensing displacement of the mass relative to one or more directions. Signals from the sensors that are dependent on the displacement of the mass may be used to determine an acceleration of the controller 721. Such techniques may be implemented by instructions from the programs for controller operation 709, which may be stored in the memory 704 and executed by the processor 703.

By way of example an accelerometer suitable as the inertial sensor may be a simple mass elastically coupled at three or four points to a frame, e.g., by springs. Pitch and roll axes lie in a plane that intersects the frame, which is mounted to the controller 721. As the controller 721 rotates about pitch and roll axes the mass will displace under the influence of gravity and the springs will elongate or compress in a way that depends on the angle of pitch and/or roll. The displacement of the mass can be sensed and converted to a signal that is dependent on the amount of pitch and/or roll. Angular acceleration about the yaw axis or linear acceleration along the yaw axis may also produce characteristic patterns of compression and/or elongation of the springs or motion of the mass that can be sensed and converted to signals that are dependent on the amount of angular or linear acceleration. Such an accelerometer device can measure tilt, roll angular acceleration about the yaw axis and linear acceleration along the yaw axis by tracking movement of the mass or compression and expansion forces of the springs. There are a number of different ways to track the position of the mass and/or the forces exerted on it, including resistive strain gauge material, photonic sensors, magnetic sensors, hall-effect devices, piezoelectric devices, capacitive sensors, and the like. In some embodiments, the inertial sensor may be removably mounted to the controller 721.

In addition, the controller 721 may include one or more light sources 734, such as light emitting diodes (LEDs). The light sources may be used to distinguish one controller from the other. For example, one or more LEDs can accomplish this by flashing or holding an LED pattern code. By way of example, five LEDs can be provided on the controller 721 in a linear or two-dimensional pattern. Although a linear array of LEDs is preferred, the LEDs may alternatively, be arranged in a rectangular pattern or an arcuate pattern to facilitate determination of an image plane of the LED array when analyzing an image of the LED pattern obtained by an external image capture unit 728. Furthermore, the LED pattern codes may also be used to determine the positioning of the controller 721 during game play. For instance, the LEDs can assist in identifying tilt, yaw and roll of the controllers. This detection pattern can assist in providing a better user/feel in games, such as aircraft flying games, etc. The image capture unit may capture images containing the controller 721 and light sources Analysis of such images can determine the location and/or orientation of the controller. Such analysis may be implemented by the game application stored in the memory 704 and executed by the processor 703. To facilitate capture of images of the light sources by the image capture unit, the light sources may be placed on two or more different sides of the controller 721, e.g., on the front and on the back (as shown in phantom). Such placement allows the image capture unit to obtain images of the light sources for different orientations of the controller 721 depending on how the controller 721 is held by a user. In alternative implementations, the image capture unit 728 may be located on the controller 721 and images of external objects may be analyzed to determine controller location and/or orientation.

In addition, the light sources may provide telemetry signals to the processor 703, e.g., in pulse code, amplitude modulation or frequency modulation format. Such telemetry signals may indicate which joystick buttons are being pressed and/or how hard such buttons are being pressed. Telemetry signals may be encoded into the optical signal, e.g., by pulse coding, pulse width modulation, frequency modulation or light intensity (amplitude) modulation. The processor 703 may decode the telemetry signal from the optical signal and execute a game command in response to the decoded telemetry signal. Telemetry signals may be decoded from analysis of images of the controller 721 obtained by the image capture unit. Alternatively, the system 700 may include a separate optical sensor dedicated to receiving telemetry signals from the lights sources. The use of LEDs in conjunction with determining an intensity amount in interfacing with a computer program is described, e.g., in U.S. patent application Ser. No. 11/429,414, to Richard L. Marks et al., entitled “USE OF COMPUTER IMAGE AND AUDIO PROCESSING IN DETERMINING AN INTENSITY AMOUNT WHEN INTERFACING WITH A COMPUTER PROGRAM”, filed May 4, 2006, which is incorporated herein by reference in its entirety. In addition, analysis of images containing the light sources may be used for both telemetry and determining the position and/or orientation of the controller 721. Such techniques may be implemented by instructions of the program for controller operation 709, which may be stored in the memory 704 and executed by the processor 703.

Alternatively, the image capture unit may be coupled to the controller 721 and light sources placed near the controller may be used with the image capture unit in determining the position of the controller. The light sources may be arranged in a light bar or as individual light sources in a known configuration. Similar to as discussed above the image capture unit may take images of the position and arrangement of light sources, which are sent to the processor 703, which may analyze the images to determine the position of the controller. In yet other alternative implementations, the image capture unit 728 coupled to the controller 721 using simultaneous localization and mapping (SLAM) to determine the position of the controller with or without light sources. Light sources may be used as landmarks for SLAM, without light sources Machine vision techniques may be used to determine landmarks around the room and SLAM may use those landmarks and apply various computational algorithms to determine the position of the controller. For more information on SLAM see: Durrant-Whyte, Hugh “Simultaneous Localization and Mapping: Part 1” IEEE Robotics & Automation Magazine. 13(2): 99-110 (2006) the contents of which are herein incorporated by reference.

The processor 703 may use the inertial signals from the inertial sensor in conjunction with optical signals from light sources detected by the image capture unit and/or sound source location and characterization information from acoustic signals detected by a microphone array 730 on the controller or located externally to deduce information on the location and/or orientation of the controller 721 and/or its user. For example, “acoustic radar” sound source location and characterization may be used in conjunction with the microphone array to track a moving voice while motion of the joystick controller is independently tracked (through the inertial sensor and or light sources). In acoustic radar, a pre-calibrated listening zone is selected at runtime and sounds originating from sources outside the pre-calibrated listening zone are filtered out. The pre-calibrated listening zones may include a listening zone that corresponds to a volume of focus or field of view of the image capture unit. Examples of acoustic radar are described in detail in U.S. patent application Ser. No. 11/381,724, to Xiaodong Mao entitled “METHODS AND APPARATUS FOR TARGETED SOUND DETECTION AND CHARACTERIZATION”, filed May 4, 2006, which is incorporated herein by reference. Any number of different combinations of different modes of providing control signals to the processor 703 may be used in conjunction with embodiments of the present invention. Such techniques may be implemented by the programs for controller operation 709 which may be stored in the memory 704 and executed by the processor 702 and may optionally include one or more instructions that direct the one or more processors to select a pre-calibrated listening zone at runtime and filter out sounds originating from sources outside the pre-calibrated listening zone. The pre-calibrated listening zones may include a listening zone that corresponds to a volume of focus or field of view of the image capture unit 728.

In alternative implementations, the microphone array 730 may be located externally and may track the controller 721 acoustically. In such implementations, the controller may include a sound emitter 736 configured to emit sounds, e.g., ultrasound, to facilitate such tracking.

The program for controller operation 709 may optionally include one or more instructions that direct the one or more processors to produce a discrete time domain input signal xm(t) from microphones M0 . . . MM, of the microphone array, determine a listening sector, and use the listening sector in a semi-blind source separation to select the finite impulse response filter coefficients to separate out different sound sources from input signal xm(t). The program for controller operation 709 may also include instructions to apply one or more fractional delays to selected input signals xm(t) other than an input signal x0(t) from a reference microphone Mo. Each fractional delay may be selected to optimize a signal to noise ratio of a discrete time domain output signal y(t) from the microphone array. The fractional delays may be selected to such that a signal from the reference microphone Mo is first in time relative to signals from the other microphone(s) of the array. The program for controller operation 709 may also include instructions to introduce a fractional time delay Δ into an output signal y(t) of the microphone array so that: y(t+a)=x(t+a)*b0+x(t−1+Δ)*b1+x(t−2+Δ)*b2+ . . . +x(t−N+Δ)bN, where Δ is between zero and ±1. Examples of such techniques are described in detail in U.S. patent application Ser. No. 11/381,729, to Xiaodong Mao, entitled “ULTRA SMALL MICROPHONE ARRAY” filed May 4, 2006, the entire disclosures of which are incorporated by reference.

The program for controller operation 709 may include one or more instructions which, when executed, cause the system 700 to select a pre-calibrated listening sector that contains a source of sound. Such instructions may cause the apparatus to determine whether a source of sound lies within an initial sector or on a particular side of the initial sector. If the source of sound does not lie within the default sector, the instructions may, when executed, select a different sector on the particular side of the default sector. The different sector may be characterized by an attenuation of the input signals that is closest to an optimum value. These instructions may, when executed, calculate an attenuation of input signals from the microphone array and the attenuation to an optimum value. The instructions may, when executed, cause an apparatus to determine a value of an attenuation of the input signals for one or more sectors and select a sector for which the attenuation is closest to an optimum value. Examples of such a technique are described, e.g., in U.S. patent application Ser. No. 11/381,725, to Xiaodong Mao, entitled “methods and apparatus for targeted sound detection” filed May 4, 2006, the disclosures of which are incorporated herein by reference.

Signals from the inertial sensor may provide part of a tracking information input and signals generated from the image capture unit from tracking the one or more light sources may provide another part of the tracking information input. By way of example, and without limitation, such “mixed mode” signals may be used in a football type video game in which a Quarterback pitches the ball to the right after a head fake head movement to the left.

Specifically, a game player holding the controller 721 may turn his head to the left and make a sound while making a pitch movement swinging the controller out to the right like it was the football. The microphone array in conjunction with “acoustic radar” program code can track the user's voice. The image capture unit can track the motion of the user's head or track other commands that do not require sound or use of the controller. The sensor may track the motion of the joystick controller (representing the football). The image capture unit may also track the light sources on the controller 721. The user may release of the “ball” upon reaching a certain amount and/or direction of acceleration of the controller 721 or upon a key command triggered by pressing a button on the controller 721.

In certain embodiments of the present invention, an inertial signal, e.g., from the inertial sensor 732, e.g., an accelerometer or gyroscope, may be used to determine a location of the controller 721. Specifically, an acceleration signal from an accelerometer may be integrated once with respect to time to determine a change in velocity and the velocity may be integrated with respect to time to determine a change in position. If values of the initial position and velocity at some times are known, then the absolute position may be determined using these values and the changes in velocity and position. Although position determination using an inertial sensor may be made more quickly than using the image capture unit and light sources the inertial sensor may be subject to a type of error known as “drift” in which errors that accumulate over time can lead to a discrepancy D between the position of the controller 721 calculated from the inertial signal (shown in phantom) and the actual position of the controller 721.

The program for controller operation 709 may optionally include processor executable instructions including one or more instructions which, when executed cause the image capture unit to monitor a field of view in front of the image capture unit, identify one or more of the light sources within the field of view, detect a change in light emitted from the light source(s); and in response to detecting the change, triggering an input command to the processor 703. The use of LEDs in conjunction with an image capture device to trigger actions in a game controller is described e.g., in U.S. patent application Ser. No. 10/759,782 to Richard L. Marks, filed Jan. 16, 2004 and entitled: METHOD AND APPARATUS FOR LIGHT INPUT DEVICE, which is incorporated herein by reference in its entirety.

The program for controller operation 709 may optionally include processor executable instructions including one or more instructions which, when executed, use signals from the inertial sensor and signals generated from the image capture unit from tracking the one or more light sources as inputs to a game system, e.g., as described above.

Although embodiments of the present invention are described in terms of examples related to a video game controller 721 games, embodiments of the invention, including the system 700 may be used on any user manipulated body, molded object, knob, structure, etc., with inertial sensing capability and inertial sensor signal transmission capability, wireless or otherwise.

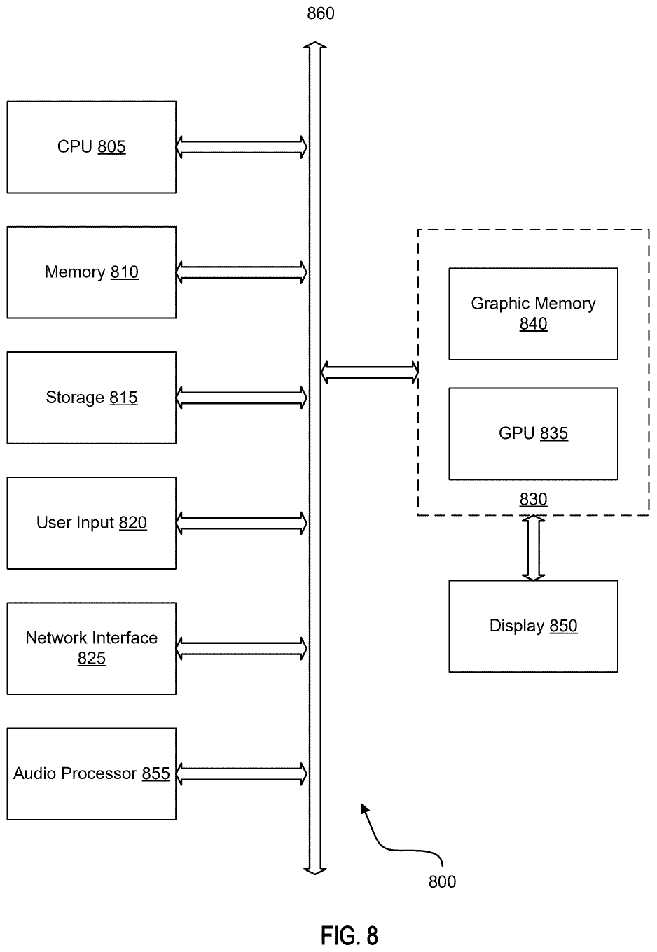

FIG. 8 illustrates an example of a hardware system suitable for implementing a computer system, according to embodiments of the present disclosure. The computer system 800 represents, for example, a video game system, a backend set of servers, or other types of a computer system. The computer system 800 includes a central processing unit (CPU) 805 for running software applications and optionally an operating system. The CPU 805 may be made up of one or more homogeneous or heterogeneous processing cores. Memory 810 stores applications and data for use by the CPU 805. Storage 815 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 820 communicate user inputs from one or more users to the computer system 800, examples of which may include keyboards, mice, thumbsticks, touch pads, touch screens, still or video cameras, and/or microphones. Network interface 825 allows the computer system 800 to communicate with other computer systems via an electronic communications network and may include wired or wireless communication over local area networks and wide area networks such as the Internet. An audio processor 855 is adapted to generate analog or digital audio output from instructions and/or data provided by the CPU 805, memory 810, and/or storage 815. The components of computer system 800, including the CPU 805, memory 810, data storage 815, user input devices 820, network interface 825, and audio processor 855 are connected via one or more data buses 860.

A graphics subsystem 830 is further connected with the data bus 860 and the components of the computer system 800. The graphics subsystem 830 includes a graphics processing unit (GPU) 835 and graphics memory 840. The graphics memory 840 includes a display memory (e.g., a frame buffer) used for storing pixel data for each pixel of an output image. The graphics memory 840 can be integrated in the same device as the GPU 835, connected as a separate device with the GPU 835, and/or implemented within the memory 810. Pixel data can be provided to the graphics memory 840 directly from the CPU 805. Alternatively, the CPU 805 provides the GPU 835 with data and/or instructions defining the desired output images, from which the GPU 835 generates the pixel data of one or more output images. The data and/or instructions defining the desired output images can be stored in the memory 810 and/or graphics memory 840. In an embodiment, the GPU 835 includes 3D rendering capabilities for generating pixel data for output images from instructions and data defining the geometry, lighting, shading, texturing, motion, and/or camera parameters for a scene. The GPU 835 can further include one or more programmable execution units capable of executing shader programs.

The graphics subsystem 830 periodically outputs pixel data for an image from the graphics memory 840 to be displayed on the display device 850. The display device 850 can be any device capable of displaying visual information in response to a signal from the computer system 800, including CRT, LCD, plasma, and OLED displays. The computer system 800 can provide the display device 850 with an analog or digital signal.

In accordance with various embodiments, the CPU 805 is one or more general-purpose microprocessors having one or more processing cores. Further embodiments can be implemented using one or more CPUs 805 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, +4%, +5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A controller for a video game system comprising:
a controller body;
a processor included in the controller body; and
a user input device communicatively coupled with the processor and attached to one or more locations on the controller body, the user input device comprising:
a graphical user interface configured to present selectable icons to control or navigate features of the video game system; and
a rotating member that rotates relative to an axis that intersects the controller body such that at least one or more of the selectable icons is selected or one or more of the features is controlled or navigated.

2. The controller of claim 1, further comprising at least two thumbsticks, the user input device being couplable between the at least two thumbsticks.

3. The controller of claim 1, wherein the user input device is removably attached to the one or more locations on the controller body.

4. The controller of claim 2, further comprising a magnetic grid interface at least partially disposed between the at least two thumbsticks, the magnetic grid interface comprising a plurality of reference locations, the user input device magnetically attached to the controller body at one or more of the reference locations.

5. The controller of claim 4, further comprising a plurality of user controls, wherein at least one of the user controls is magnetically attached to the controller body at one or more corresponding reference locations of the magnetic grid interface.

6. The controller of claim 1, the controller body further comprising a front surface and a back surface.

7. The controller of claim 6, wherein the graphical user interface is disposed on the front surface and the rotating member is attached to the back surface of the controller body.

8. The controller of claim 6, wherein the user input device is attached to a top surface of the controller body.

9. The controller of claim 1, wherein at least a portion of the user input device is inwardly clickable for selecting one or more icons displayed on the graphical user interface.

10. The controller of claim 1, wherein the graphical user interface is a touchscreen for receiving touch input from a user for selecting one or more icons displayed on the graphical user interface.

11. The controller of claim 1, wherein the user input device is further configured to present, via the graphical user interface, a non-video game feature and to cause the processor to instruct the video game system about pausing a video game execution upon a selection of the non-video game feature via the graphical user interface or the rotating member.

12. The controller of claim 1, further comprising:
a wireless network interface housed in the controller body and coupled with the processor, wherein the processor is configured to receive notification information of the video game system via the wireless network interface, and, wherein the user input device is configured to receive, from the processor, the notification information and to present corresponding one or more notifications at the graphical user interface.

13. The controller of claim 12, wherein the one or more notifications comprise an incoming call alert or text message that is reviewable via the user input device.

14. The controller of claim 13, wherein the processor is configured to receive user input via the user input device in response to the one or more notifications causing a gaming application in progress to be paused.

15. A system comprising:
a video game console; and
a controller communicatively couplable with the video game console and comprising:
a controller body;
a processor included in the controller body; and
a user input device communicatively coupled with the processor and attached to one or more locations on the controller body, the user input device comprising:
a graphical user interface configured to present selectable icons to control or navigate features of the video game system; and
a rotating member that rotates relative to an axis that intersects the controller body such that at least one or more of the selectable icons is selected or one or more of the features is controlled or navigated.

16. The system of claim 15, further comprising:
a wireless network interface housed in the controller body and coupled with the processor, wherein the processor is configured to receive notification information of the video game system via the wireless network interface, and, wherein the user input device is configured to receive, from the processor, the notification information and to present corresponding one or more notifications at the graphical user interface.

17. The system of claim 16, wherein the one or more notifications comprise an incoming call alert or text message that is reviewable via the user input device.

18. The system of claim 17, wherein the processor is configured to receive user input via the user input device in response to the notification information causing a gaming application in progress to be paused.

19. A method comprising:
receiving user input via a graphical user interface or a rotating portion of a user input device, the user input device attached to a controller body of a controller, the controller communicatively coupled with a video game system, wherein:
the graphical user interface presents selectable icons to control or navigate features of the video game system, and
the rotating portion rotates relative to an axis that intersects the controller body such that at least one or more of the selectable icons is selected or one or more of the features is controlled or navigated; and
sending a signal corresponding to the user input to the video game system, the signal causing a feature of the video game system to be controlled or navigated.

20. The method of claim 19, further comprising:
receiving notification information;
presenting corresponding one or more notifications at the graphical user interface;
pausing causing a gaming application in progress; and
receiving user input via a graphical user interface or a rotating portion of a user input device in response to the one or more notifications.
